(19) United States
(12) Patent Application Publication
(10) Pub. No.: US 2005/0286184 A1
(43) Pub. Date: Dec. 29, 2005

(54) Electrical power outlet strip

(76) Inventor: Steve Campolo, Malverne, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/148,219

(22) Filed: Jun. 9, 2005

Related U.S. Application Data
(60) Provisional application No. 60/581,895, filed on Jun. 22, 2004.

(51) Int. Cl. H02H 3/00

(52) U.S. Cl. 361/42

(57) ABSTRACT

The power strip of the present disclosure includes an arc fault circuit interrupter (AFCI) to interrupt power to electrical devices plugged into the power strip when arcing is detected and, when combined with a transient voltage surge suppressor (TVSS) device and/or a ground fault circuit interrupter (GFCI) also can provide transient voltage surge suppression and ground fault protection. The power strip here disclosed can include an AFCI by itself or an ACFI in combination with a GFCI.

This application claims the benefit of the filing date of a provisional application having Ser. No. 60/581,895, which was filed on Jun. 22, 2004.

### BACKGROUND

1. Field of the Invention

The present invention relates to an electrical power outlet strip.

2. Description of the Prior Art

Circuit breakers, fuses and ground fault circuit interrupters (GFCIs) are used to protect personnel and property from electrical faults. Electrical arcs can be dangerous because the high temperatures which are generated may cause damage.

An arc may not trip a GFCI unless there is a sufficient current leakage to ground. Further, an arc may trip a circuit breaker only if the current flowing through the arc exceeds the trip parameters of the thermal/magnetic mechanism of the breaker. An arc detector can be used to detect the occurrence of an arc on an electrical line. The output of the arc detector that can be used to trigger a circuit interrupting mechanism is referred to as an arc fault circuit interrupter (AFCI).

A dangerous condition can develop whenever prolonged arcing exists regardless of whether it involves industrial, commercial or residential power lines. However, the causes of arcing are numerous and include aged or worn insulation and wiring; over currents; loose connections; and/or excessive mechanical damage to insulation and conductors. Two types of arcing are: contact arcing and line arcing. Contact (or series) arcing occurs between two conductors that are in series with a load. In this instance, the load controls the current flowing in the arc. Line (or parallel) arcing occurs between conductors or from a conductor to ground. In line arcing, the arc is in parallel with the load and the source impedance is the only limit to the current flowing in the arc.

FIG. 1 illustrates an example of contact arcing. Conductors 114, 116 including a cable 110, may be separated and surrounded by an insulator 112. A portion of the conductor 114 is broken, creating a series gap 118 in conductor 114. Arcing that occurs across the gap 118 will produce heat that may be sufficient to break down and carbonize the insulation 119 in the vicinity of the arc. If the arc is allowed to continue, enough heat may be generated to start a fire.

FIG. 2 illustrates an example of line arcing. Cable 120 includes electrical conductors 124, 126 covered by outer insulation 122 and separated by inner insulation 128. Deterioration or damage to the inner insulation at 121 may cause line arcing 123 to occur between the two conductors 124, 126. The inner insulation could have been damaged by, for example, carbonization by an earlier lightning strike to the wiring system or physical damage through abuse.

FIG. 3 shows the wide spectrum noise 162 that an arc can produce on an AC line by an arc as may be found in residential and commercial wiring. An arc generates a higher frequency component on the lower frequency electrical current on the AC electrical lines. One type of arc detector detects the higher frequency signals generated on the AC line by arcs. The higher frequency component is superimposed over the AC line voltage 164. Overtones and higher frequency harmonics contained within the waveform can extend well into the gigahertz (GHz) range. FIG. 4 is a graph illustrating a possible frequency spectrum of the waveform 162 shown in FIG. 3.

False tripping occurs when an arc detector produces a warning output, or disconnects a section of wiring from the voltage source, when a dangerous arcing condition does not actually exist. One cause of false tripping can be inrush currents created by inductive and capacitive devices. These currents can produce high frequency signals on the power line that may be similar to those generated by arcing.

FIG. 5 illustrates an implementation of a power strip 500 that may be used include a circuit that protects the electrical devices plugged into the power strip from a transient voltage spike on the incoming power line. Present day conventional electrical power strips include at least one power outlet 502 into which an electrical device can be plugged, and may also contain a connector port 504 that can receive a Universal Serial Bus (USB) cable, CATV cable 508 and/or a BNC connector 506. An indicator 510 may be included to indicate when the power outlets are energized. Transient voltage surge suppression (TVSS) devices, including a metal oxide varistor (MOV), may be electrically connected between line-side phase and neutral conductors or terminals of the power strip to protect the plugged in electrical devices from transient over-voltages. TVSS devices, commonly referred to as surge suppressors or voltage-clamping devices, can include nonlinear, voltage-dependent resistive elements which can display electrical behavior similar to that exhibited by a pair of series connected, back to back zener diodes. At voltages below a TVSS clamping voltage level, TVSS devices exhibit a high resistance with a small leakage current. When subjected to a transient voltage above the TVSS clamping voltage, the TVSS device can exhibit a low resistance region to enable a large current to flow through the device. The increase current produces an increased voltage drop across the source impedance, effectively clamping the transient voltage to a predetermined level. The surge energy can be dissipated or passed through the voltage clamping TVSS device and its operating current returns to its normal range after the surge. TVSS devices include avalanche diode suppresser, metal oxide varistors (MOVs) and selenium surge suppresser.

Ground Fault Circuit Interrupters (GFCIs) can be used to help protect against electrical shock due to ground faults. A GFCI may include a differential current detector operative to trip a contact mechanism when a predetermined current (e.g., 5 mA or more) of unbalanced current is detected between a phase (hot or Ø) conductor and the neutral (N) conductor of an AC electrical power line. The unbalanced current detected is assumed to be flowing through a human accidentally touching the phase conductor. The current flows through the human to ground rather than returning through the differential transformer via the neutral conductor, thus creating the current imbalance described above. Faults in a load, such as an appliance, connected to the AC power line also may cause a current imbalance and trip the GFCI and disconnect the current to the load.

FIG. 6 illustrates a schematic diagram of a prior art ground fault circuit interrupter device. The typical prior art GFCI, generally referenced 12, comprises two current transformers consisting of magnetic cores 48, 50 and coils 52, 54, respectively, coupled to integrated circuit 40 which may comprise the LM1851 manufactured by National Semiconductor. A relay coil 30 is placed between the phase and one input to a full wave bridge rectifier. The AC power from the phase 14 and neutral 16 conductors is full wave rectified via a full wave rectifier comprising diodes 20, 22, 24, 26. A metal oxide varistor (MOV) 18 is placed across phase and neutral for protection. The output of the bridge is coupled across capacitor 28 and silicon controlled rectifier (SCR) 32. The gate of the SCR is coupled to ground via capacitor 38 and to pin 1 of IC 40.

A diode 70 is placed across the coil 52 which is coupled to pins 2 and 3 via resister 62 and capacitors 64, 60. Pin 3 is also coupled to ground via capacitor 36. Coil 54 is coupled to pins 4 and 5 of IC 40 via capacitors 58, 56. Pin 4 is also coupled to ground. Pin 6 of IC 40 is coupled to pin 8 via resister 44 and pin 7 is coupled to ground via capacitor 42. Pin 8 is also coupled to capacitor 34 and to resister 46. The voltage on pin 8 serves as the 26 V supply voltage for the GFCI circuitry.

Line side electrical conductors, phase 14 and neutral 16, pass through the transformers to the load side phase and neutral conductors. A relay, consisting of switches 66, 68, associated with the phase and neutral conductors, respectively, function to open the circuit in the event a ground fault is detected. The switches 66, 68 are part of a double throw relay which includes coil 30. The coil 30 in the relay is energized when the GFCI circuitry turns on the silicon controlled rectifier (SCR) 32. In addition, the GFCI 12 comprises a test circuit comprised of momentary push button switch 49 connected in series with a resister 15. When the switch 49 is pressed, a temporary simulated ground fault, i.e., a temporary differential current path, from phase to neutral is created in order to test the operation of the GFCI 12.

### SUMMARY OF THE DISCLOSURE

The power strip of the present disclosure comprises an arc fault circuit interrupter (AFCI) to interrupt power to electrical devices plugged into the power strip when arcing is detected and, when combined with a TVSS device and/or a ground fault circuit interrupter (GFCI) can also provide transient voltage surge suppression and ground fault protection.

Some implementations of the invention include one or more of the following advantages. Separating the detection of the AC line current and the high frequency energy generated by the arc provides increased immunity to noise. The arc detection device detects the current flowing in the AC line across a wide range of frequencies. By splitting the two current signal components and setting a maximum permitted level of high frequency component for a given level of AC line current, the arc detector in the power strip provides increased immunity to noise. Also, the arc detector simultaneously performs average and peak detection of AC line current and high frequency arcing signal. The peak AC line current and high frequency arcing signals are detected to provide a response to large increases in either arcing or AC line current. The arc detector will trip the relay when either the peak AC line current signal or the peak high frequency arcing signal crosses a predetermined threshold.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest terms.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 is a schematic diagram illustrating an example of contact arcing in a current carrying conductor;

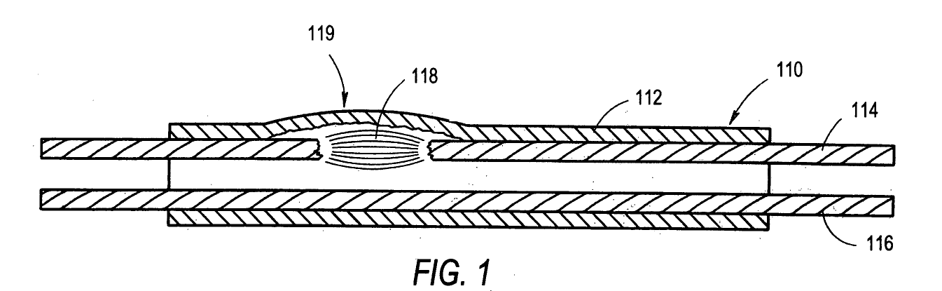

FIG. 2 is a schematic diagram illustrating an example of line arcing between two current carrying conductors;

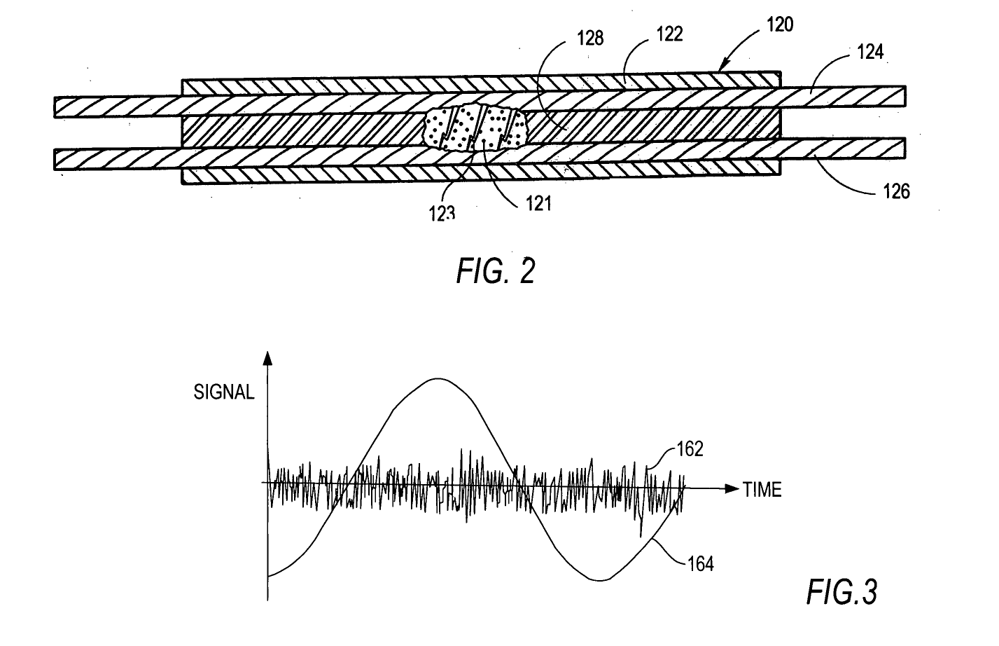

FIG. 3 is a graph illustrating the wide spectrum noise due to the EMF voltage generated by an arc propagating over the power line superimposed over the AC line voltage;

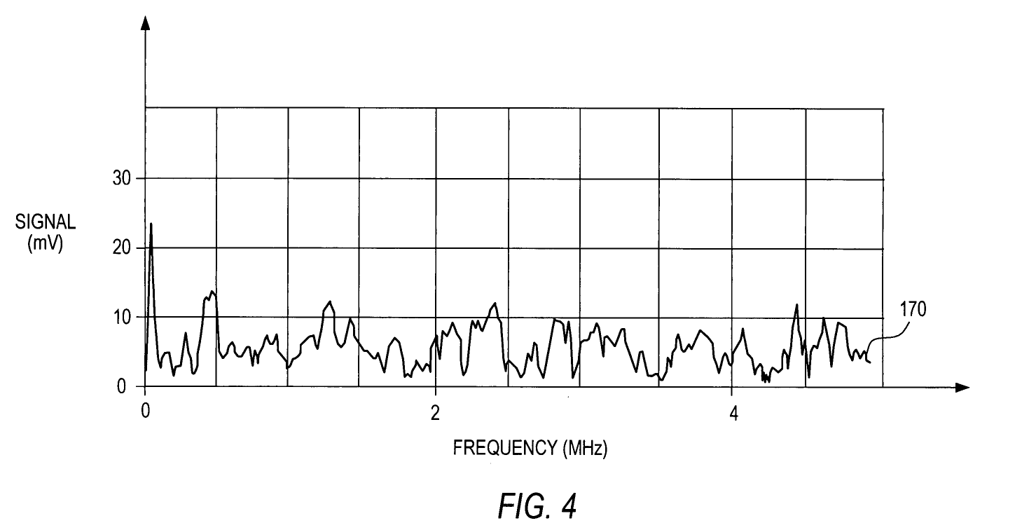

FIG. 4 is a graph illustrating frequency spectrum analysis of the waveform shown in FIG. 3;

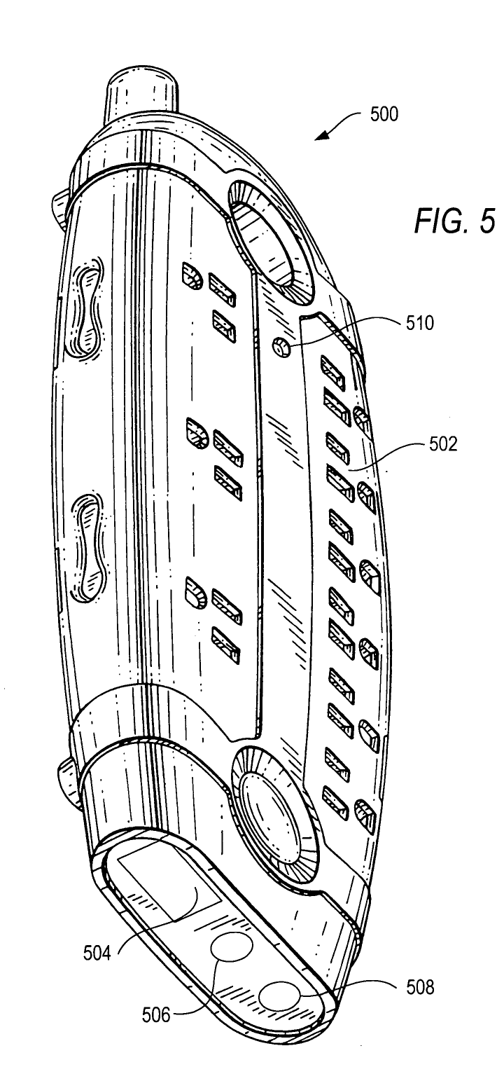

FIG. 5 is a view of a power strip having an arc fault circuit interrupter, either separately or in combination with a transient voltage surge suppression circuit where the arc fault circuit interrupter can include a ground fault circuit interrupter;

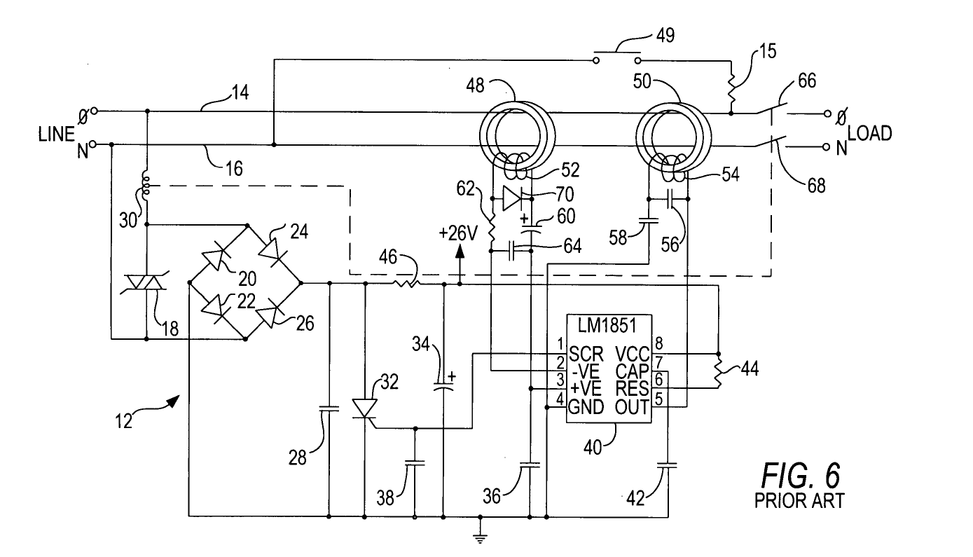

FIG. 6 is a schematic diagram illustrating an example of a prior art ground fault circuit interrupter device;

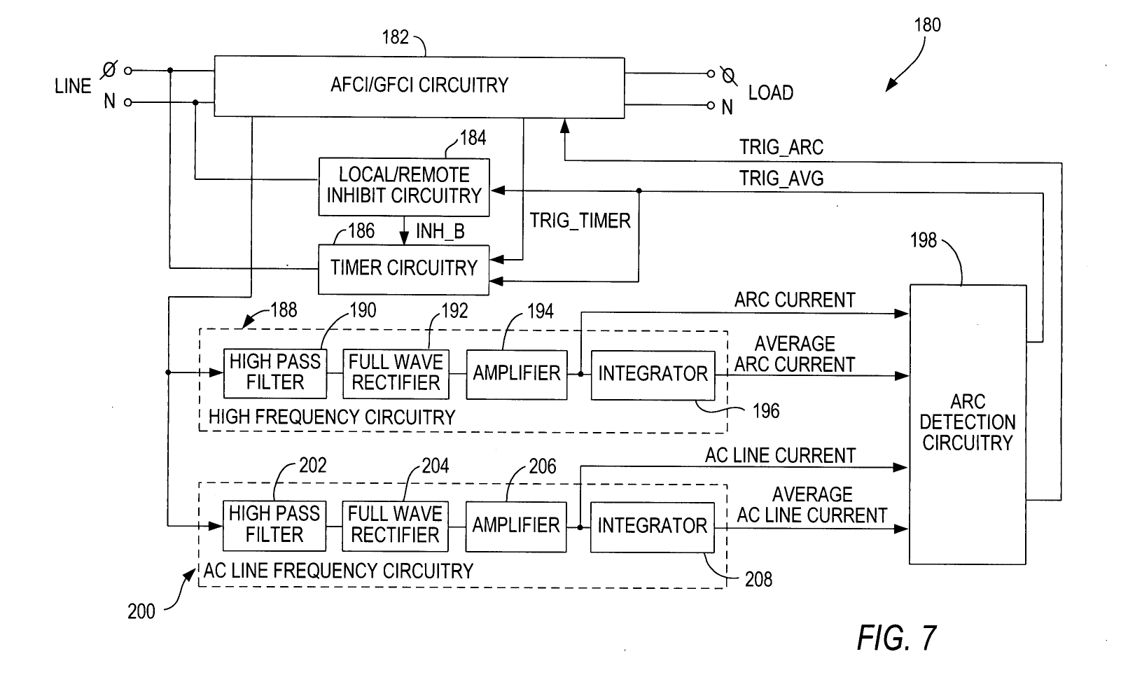

FIG. 7 is a high level block diagram illustrating the combination arc fault detector and ground fault circuit interrupter which can be in a power strip;

FIG. 8 is a schematic diagram showing the circuitry portion of the power strip more detail;

FIG. 9 is a graph illustrating the transformer output voltage versus time for varying amounts of current;

FIG. 10 is a graph illustrating the transformer output voltage versus time for a 28 A of current with the AC line voltage superimposed over it;

FIG. 11 is a graph illustrating the substantially linear relationship between the transformer output voltage and the input current;

FIG. 12 is a schematic diagram illustrating the high frequency circuitry portion of the arc fault detection device of the present disclosure in more detail;

FIG. 13 is a schematic diagram illustrating the AC line frequency circuitry portion of the arc fault detection device of the present disclosure in more detail;

FIGS. 14A, 14B and 14C are schematic diagrams illustrating the arc detection circuitry portion of the arc fault detection device of the present disclosure in more detail;

FIG. 15 is a schematic diagram illustrating the timer circuitry portion of the arc fault detection device of the present disclosure in more detail;

FIG. 16 is a schematic diagram illustrating the local/remote inhibit circuitry portion of the arc fault detection device of the present disclosure in more detail; and

FIG. 17 is a block diagram of a method of arc fault current interrupter in accordance with the present disclosure.

### DETAILED DESCRIPTION

The power strip of the present disclosure includes an arc fault circuit interrupter (AFCI) to interrupt power to electrical devices plugged into the power strip when arcing is detected and, when combined with a transient voltage surge suppressor (TVSS) device and/or a GFCI also can provide transient voltage surge suppression and ground fault protection. The power strip can include an AFCI by itself or an ACFI in combination with a GFCI. When the AFCI is used in combination with a GFCI, various parts of the GFCI are also used by the AFCI. Therefore, the description which follows is directed toward an AFCI in combination with a GFCI, it being understood, however, that the power strip can include an AFCI and only those parts of the GFCI which are used by the AFCI to be fully functional.

The techniques disclosed can also be applied to devices that distribute incoming data signals to one or more data outlet connectors. For example, the outlet strip can have a connector to receive incoming data from a telephone line. The incoming data may be protected by a TVSS and coupled through the AFCI and GFCI to the data outlet connector. The incoming data also may be received from a modem, a cable television (CATV), Ethernet, BNC, video, token ring, satellite or digital subscriber line (DSL), The arc detector in the power strip can monitor and sense the line voltage and current present on the AC power line for the occurrence of arcing. Both high frequency energy and AC line frequency energy can be utilized in the detection of arc faults. The output of the detector may be used to activate a circuit interrupting mechanism, sound an audio alarm and/or alert a central monitoring station.

The power strip can include the arc detector in combination with an existing circuit interrupting device. It also can include the arc detector in combination with a transient voltage surge suppression device. The term ‘circuit interrupting device’ is defined to mean any electrical device used to interrupt current flow to a load including Ground Fault Circuit Interrupters (GFCI), Immersion Detection Circuit Interrupters (IDCI) or Appliance Leakage Circuit Interrupters (ALCI).

The arc detector can combine an arc fault circuit interrupter (AFCI) with other types of circuit interrupting devices such as a GFCI, IDCI or ALCI to create an AFCI/GFCI, AFCI/IFCI or AFCI/ALCI multipurpose device. In the case of combining an AFCI with a GFCI in a power strip, the arc detection circuitry can be placed onboard the same silicon chip used in the GFCI devices. The AFCI can be powered from the same power supply that provides power to the circuit interrupting device. This combined approach results in reduced manufacturing costs. The mechanical parts of the circuit interrupting device such as the trip relay and the mechanical contact closure mechanisms of the GFCI now serve dual purposes. Adding AFCI circuitry to an existing circuit interrupting device such as that portion of a GFCI may be a logical enhancement of such present day devices. In some instances it is logical to enhance an AFCI with GFCI circuitry because a GFCI can detect arcing in certain situations such as where an arc produces leakage current to ground.

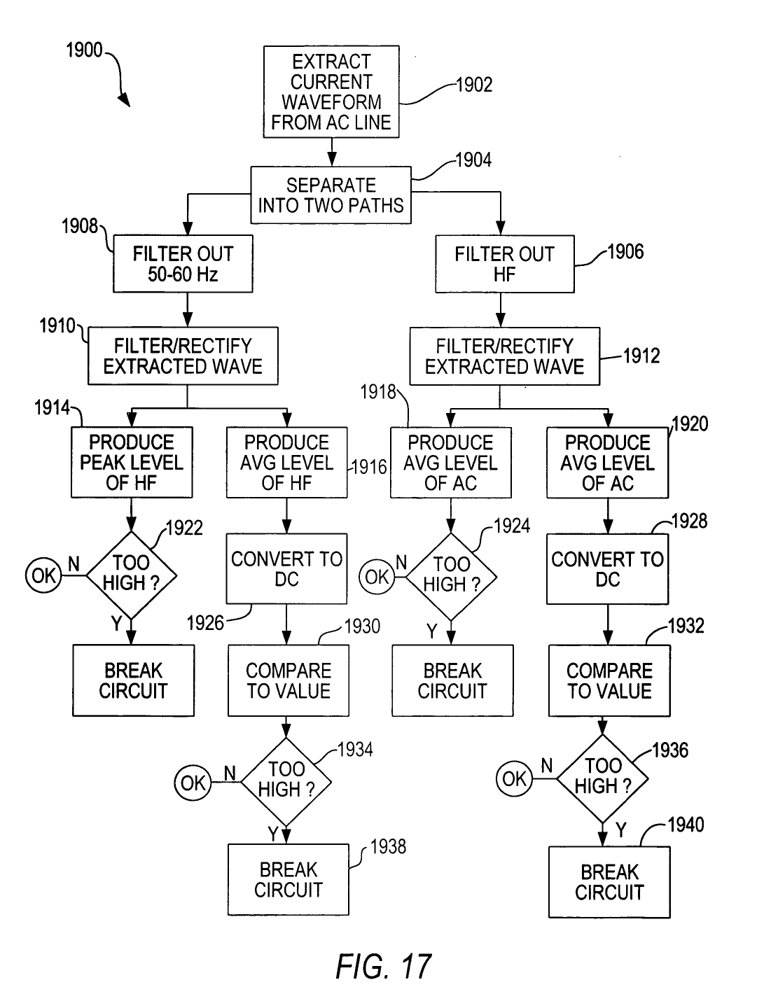

FIG. 17 is a block diagram 1900 of method of implementing an AFCI. In a power strip having an AFCI device, the input current waveform present on the AC line may be extracted 1902 by, for example, a toroidal current to voltage transformer. The voltage that is generated across the secondary windings of the transformer may be separated 1904 into two paths. In a first path, the 50 or 60 Hz AC line frequency content of the transformer output is filtered 1906 from the input current waveform. This AC line frequency signal can provide an indication of the amount of current flowing through the AC power line. In a second path, the high frequency (HF) content of the transformer output is filtered 1908 from the input current waveform. The high frequency signal can be indicative of the level of arcing present on the AC power line.

Within each of the two paths, the signals are filtered by a second stage filter and then rectified 1910, 1912. The two rectified signals are each split to produce peak 1914, 1918 and average levels 1916, 1920 for the AC line frequency and high frequency signals, respectively. Peaks in either the AC line frequency 1922 or high frequency 1924 path can cause the trip relay and mechanical contact closure mechanism such as is used with a GFCI more fully disclosed in U.S. Pat. No. 5,202,662 and which is incorporated herein by reference in its entirety to trip, disconnecting the load from the power source.

The absolute average levels of the AC line frequency and high frequency signals are converted 1926, 1928 to a DC potential and compared 1930, 1932 to a set of predefined voltages. If the average high frequency signal is greater 1934, 1936 than the level expected from normal device arcing at the associated average AC line frequency level, then an output signal is generated. This output signal is then used to trip 1938, 1940 the device. In an implementation, a user can disable the AFCI function temporarily or permanently if desired to prevent tripping the arc detector.

Thus, the detection of high average AC line frequency or high frequency signals causes the device to trip.

The arc detection device can detect the current flowing in the AC line across a wide range of frequencies. By splitting the two current signal components and setting a maximum permitted level of high frequency component for a given level of AC line current, the arc detector in the power strip can provide an increase in immunity to noise.

The arc detector simultaneously can perform average and peak detection of AC line current and high frequency arcing signal. The peak AC line current and high frequency arcing signals can be detected to provide an immediate response to large increases in either arcing or AC line current. The arc detector will trip the relay in response to a peak AC line current signal or the peak high frequency arcing signal crossing a predetermined a predetermined threshold.

In some implementations, the arc detector can incorporate a fast trip circuit, which functions to open the relay when excessive average AC line current and high frequency arcing levels are detected. If either the average AC line current or the average high frequency arcing signal rises above a predetermined level, the device will trip very quickly. In a particular implementation, the maximum level for the average AC line current is approximately 1.5 times the rated AC line current. The limit set for the average high frequency signal can be a level of average arcing that is known to be dangerous.

When the levels of average AC line current and high frequency signal are lower than their respective maximums, the arc detector can utilize various trip levels for arcing, dependent upon the level of the average AC current flowing. The arc detector may trip at a slower speed at these lower arcing levels. This slower trip response time provides noise immunity against short lived noise and arcs. By incorporating various trip times, dependent on the level of arcing detected, the arc detector can extinguish specified higher level arcs quickly while providing high noise immunity for lower level arcs.

The arc detector also may incorporate an automatic bypass timer to permit otherwise normally safe arcing. This logic switch can provide a user with the option of disabling the arc detector for as long as the switch is off or disabling the arc detector temporarily, to allow for an electrical noisy environment. This timing feature may permit the use of appliances that normally generate high amounts of arcing that would otherwise cause the arc detector to trip. When the arc detector is temporarily disabled, it can automatically returns to the enabled state after the appliance has been disconnected. This scheme has the advantage that the device cannot accidentally be permanently disabled by the user. An important feature of this scheme is that the arcing appliance can be turned on and off within the given time period without tripping the arc detector.

The arc detector can include circuitry to transmit messages using any suitable communication means pinpointing the location of arc fault. For example, such communication means may comprise any power line carrier, RF, twisted pair or IR communication technology. The arc detector can communicate with other devices such as a monitoring station. Each arc detector may have a unique address. A relationship can be established between the address assigned to the arc detector and the arc detector's location. In the event that an arc fault is detected, a signal can be sent over the power lines to a monitoring station which alerts personnel of not only the occurrence of the arc fault but also its location.

The AC power lines also can be used as a medium for communications. The arc detector of the present disclosure can include a filter circuit that permits the detection of arc faults while communications over the AC power lines is occurring. The filter circuit can function to remove frequencies below a specified frequency, such as 500 KHz.

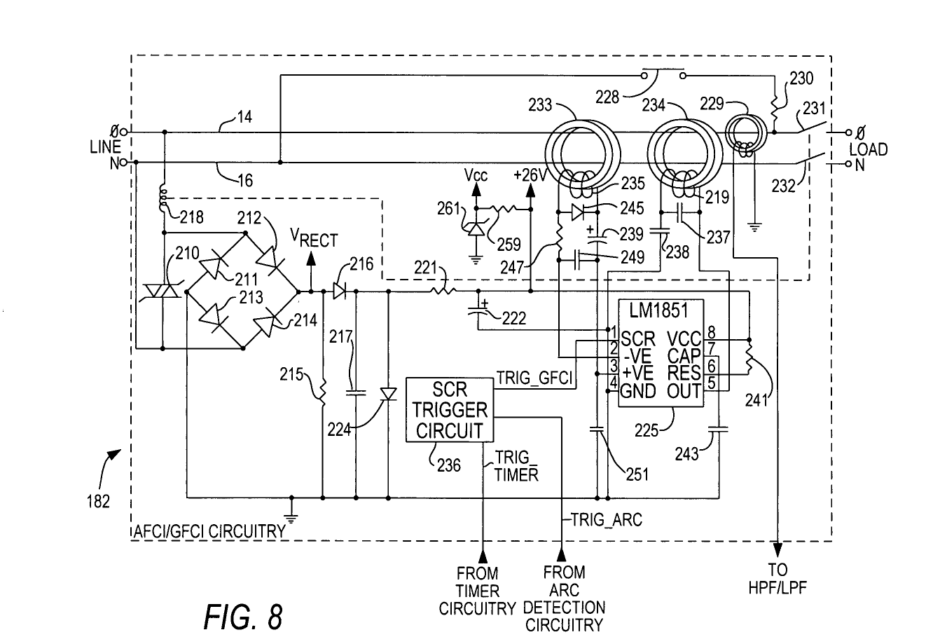

FIG. 7 is a block diagram of an implementation of an arc fault circuit interrupter device. The description that follows is within the context of a combination arc fault circuit interrupter/ground fault circuit interrupter (AFCI/GFCI) device. Other types of circuit interrupting devices such as IDCIs or ALCIs can be combined with the arc fault detector in similar fashion, or that the AFCI can operate as a stand alone device when combined with those parts of the GFCI which are used in common.

The AFCI/GFCI device, generally referenced 180 and hereinafter referred to as the device, comprises AFCI/GFCI circuitry 182, AC line frequency circuitry 200, high frequency circuitry 188, arc detection circuitry 198, local/remote inhibit circuitry 184 and timer circuitry 186. The AFCI/GFCI circuitry 182 comprises a standard GFCI device in addition to several components that are shared between the AFCI and the GFCI portions of the device. The device is a four terminal device comprising line side phase and neutral leads as well as line side phase and neutral leads coupled to a source of power. The device itself may be located in a power strip and with the line side phase and neutral terminals electrically connected to a source of AC power. The load side phase and neutral terminals can be connected to receptacles in the face of the power strip for connection, by a plug, for example, to an electrical device.

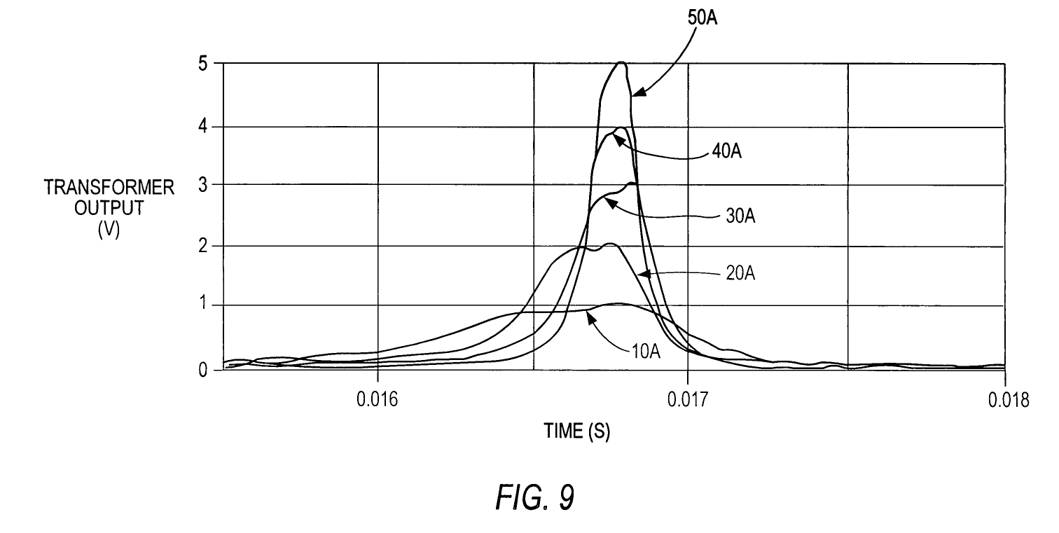

FIG. 8 is a schematic diagram of an implementation of AFCI/GFCI circuitry portion of the arc fault detection device in accordance with the present disclosure. The GFCI portion of the device is described briefly below. A description of a GFCI circuit can be found in U.S. Pat. No. 5,202,662, to Bienwald et al. and incorporated herein by reference in its entirety.

A GFCI is an electrical device that can detect grounding conditions in consumer and industrial environments. Unbalanced current through a differential transformer 233 can be sensed by the circuitry. When the current imbalance is above a specified threshold, which may have been determined as dangerous to personnel or machinery, the integrated circuit (IC) 225 triggers SCR 224. The SCR 224, in turn, can activate a coil 218 of a relay circuit breaker comprising phase contacts 231 and neutral contacts 232. Activation of the coil can open the phase and neutral contacts to disconnect the source of electrical power from the load. When the GFCI circuitry detects a ground fault, a signal line TRIG_GFCI is made active. In an implementation, an SCR trigger circuit 236 has three trigger inputs, TRIG_GFCI, TRIG_TIMER and TRIG_ARC representing a fault signal from the GFCI circuitry, a timing circuit and the AFCI circuitry, respectively. The three trigger signals are in an inactive state when there in no fault detected. Any or all of the three trigger inputs going active can cause the SCR trigger circuit generate a switching signal to turn the SCR 224 on.

A second differential transformer 234 within the AFCI/GFCI circuitry can be provided to detect a low impedance condition between the load side neutral conductor and ground. A low impedance neutral/ground connection allows ground fault current to leak back from the ground to the neutral conductor passing through the differential transformers. This reduces the sensitivity of the GFCI and can permit ground faults to occur without the GFCI tripping. If the impedance of the neutral/ground connection becomes too low, the IC 225 triggers the SCR 224 by activating the TRIG_GFCI signal, thus disconnecting both phase and neutral from the load.

As described previously, the ground/neutral transformer 234 can be used to detect ground to neutral faults. In the present disclosure this transformer is utilized to perform two functions simultaneously. For detecting ground faults, this transformer is used in a differential mode. The sum of the currents, in the two conductors passing through its center, is zero in the absence of a ground fault or ground/neutral fault.

The AFCI/GFCI circuit, generally referenced 182, comprises two current transformers consisting of magnetic cores 233, 234 and coils 235, 219, respectively, coupled to integrated circuit 225 which may comprise a LM1851 Ground Fault Interrupter manufactured by National Semiconductor or the RA9031 manufactured by Raytheon. The AC power from the phase 14 and neutral 16 conductors is full wave rectified by a full wave rectifier comprising diodes 211, 212, 213, 214. A metal oxide varistor (MOV) 210 can be placed across phase and neutral for protection. The voltage output of the bridge, represented as VRECT is coupled across capacitor 215 and in series with a diode 216. The cathode of the diode 216 is coupled to a capacitor 217 and to SCR 224. The gate of the SCR is coupled to the output of an SCR trigger circuit 236. The output of pin 1 of IC 225 forms one of the inputs to the SCR trigger circuit 236.

A diode 245 is placed across the coil 235 which is coupled to IC 225 pins 2 and 3 through resistor 247 and capacitors 239, 249. Pin 3 also is coupled to ground through capacitor 251. Coil 219 is coupled to pins 4 and 5 of IC 225 through capacitors 237, 238. Pin 4 also is coupled to ground. Pin 6 of IC 225 is coupled to pin 8 by resistor 241 and pin 7 is coupled to ground through capacitor 243. Pin 8 is also coupled to capacitor 222 and to resistor 221. The voltage on pin 8 can provide supply voltage, 26 VDC for example, for the GFCI circuitry. The 26 V is coupled to a resistor 259 and a zener diode 261 which may be used to provide a lower VCC supply voltage for use by internal circuitry of the AFCI/GFCI.

Line side electrical conductors, phase 14 and neutral 16, pass through the transformers to the load side phase and neutral conductors connected to the receptacles in the power strip. A relay, having switches 231, 232, associated with the phase and neutral conductors, respectively, may be operable to open the circuit in the event a ground fault is detected. The switches 231, 232 are part of a double throw relay which includes coil 218. The coil 218 in the relay is energized when the AFCI/GFCI circuitry turns on the SCR 224. In a n implementation, a momentary push button switch 228 connected in series with a resistor 230. When the switch 228 is pressed, a temporary ground fault from phase to neutral is created in order to test the operation of the device.

The AFCI and GFCI circuit portions operate independently from one another but share several components. With reference to FIG. 8, both circuits can be powered from the line side of the AC power source through the same power supply. Resistor 259 and zener diode 261 can be arranged to step the GFCI circuitry voltage down to a level that may be required for other parts of the circuitry. The VCC output voltage may be provided to both AFCI and GFCI circuit portions. Both AFCI and GFCI circuits operate to interrupt the AC power by opening two sets of contacts 231, 232 by actuation of the relay coil 218. The relay coil is actuated by triggering the SCR 224 via the SCR trigger circuit 236. The triggering signal from the GFCI and the triggering signal from the AFCI are separate signals. The SCR trigger circuit can provide an OR type logic operation to trigger the SCR 224 when either of its three input triggers TRIG_GFCI, TRIG_TIMER or TRIG_ARC go active.

The AFCI/GFCI circuitry also includes a toroidal current to voltage transformer 229 which can be positioned on either the phase or neutral line of the AC power source. In the illustrated configuration, the transformer has the phase line passing through it. Alternatively, the neutral conductor can pass through the transformer. The turns ratio of the transformer 229 can be calculated to generate a primary current to secondary voltage ratio of approximately 10 A to 1 V peak. The transformer 229 may be constructed from ferrite material capable of detecting a wide band of frequencies which may range range from a few Hz to MHz. A wideband transformer 229 can improve the response of the AFCI to low and high frequencies that can be generated by arc faults.

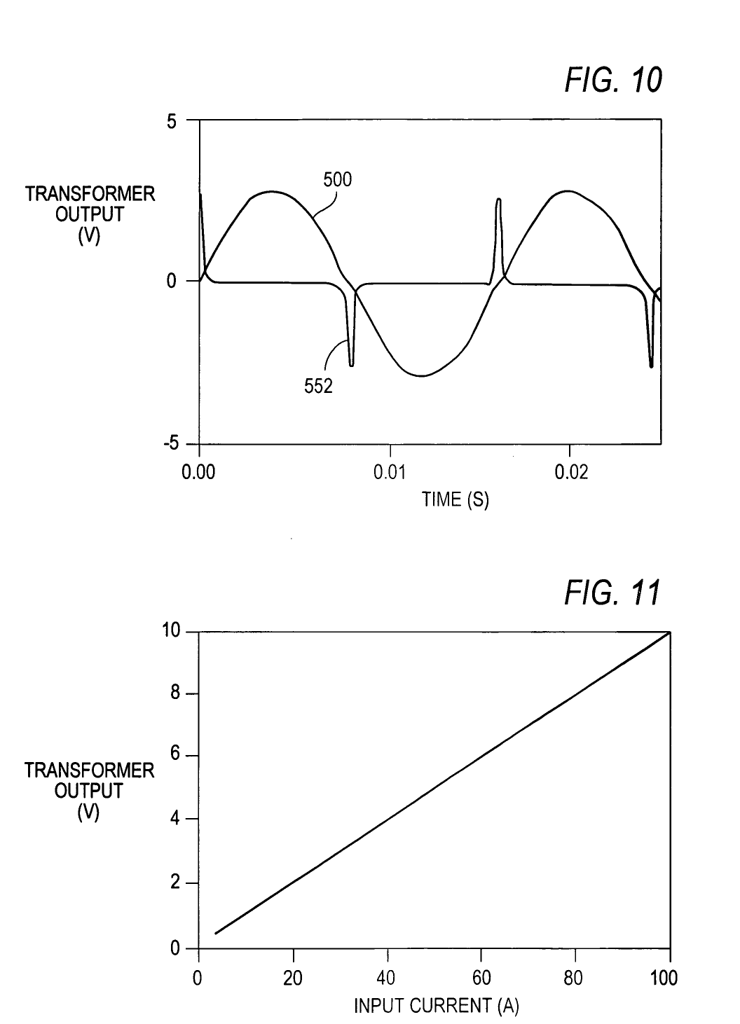

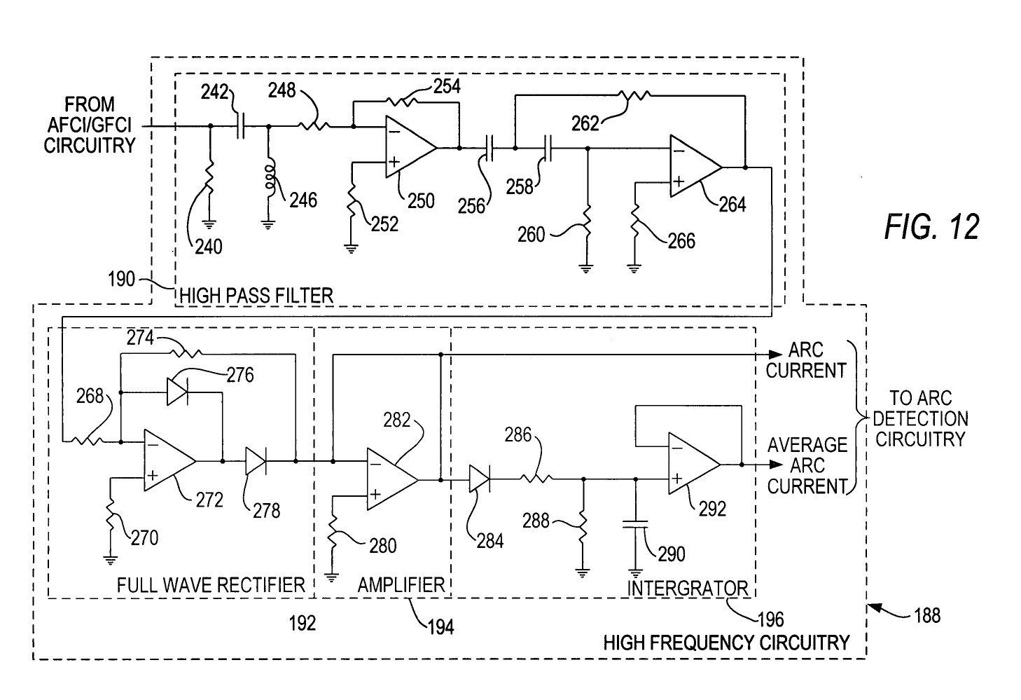

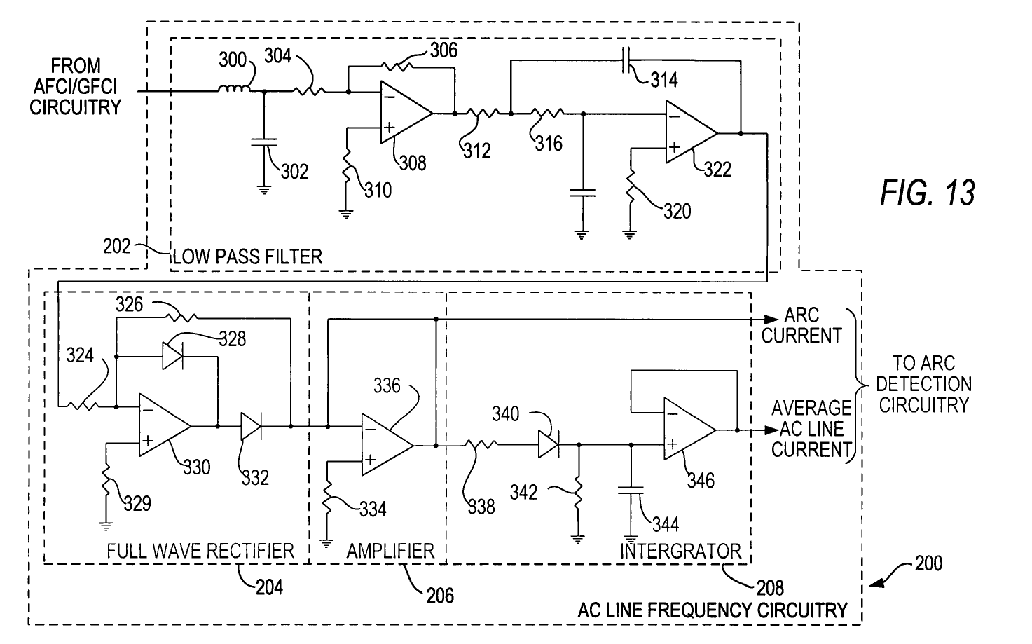

FIGS. 9-11 illustrate the relationship of input current to transformer output voltage. In an implementation, at currents greater than 1 Ampere, the transformer 229 can generate a peak output voltage that is substantially linearly proportional to the peak current flowing through it. FIG. 9 is a graph illustrating the transformer output voltage versus time for varying amounts of current. FIG. 10 is a graph illustrating the transformer output voltage versus time for a 28 A of current with the AC line voltage superimposed over it. FIG. 11 is a graph illustrating the substantially linear relationship between the transformer output voltage and the input current.

This relationship of input current to transformer voltage output may result whether the load is resistive, capacitive, inductive or a combination of all three. Thus, the type of load connected to the device does not affect arc detection.

Referring again to FIG. 7, the output of the transformer 229 is input to two separate circuits. One circuit being the high frequency (HF) circuit 188 comprising a high pass filter 190, full wave rectifier 192, amplifier 194 and integrator 196. The second circuit being the AC line frequency circuit 200 comprising low pass filter 202, full wave rectifier 204, amplifier 206 and integrator 208. The splitting of the output signal from the transformer 229 into two signals of different frequencies can permit the disclosed device to react to different combinations of AC line frequency and high frequency arcing signals. This can permit the AFCI circuit to react differently to different arcing and over current combinations.

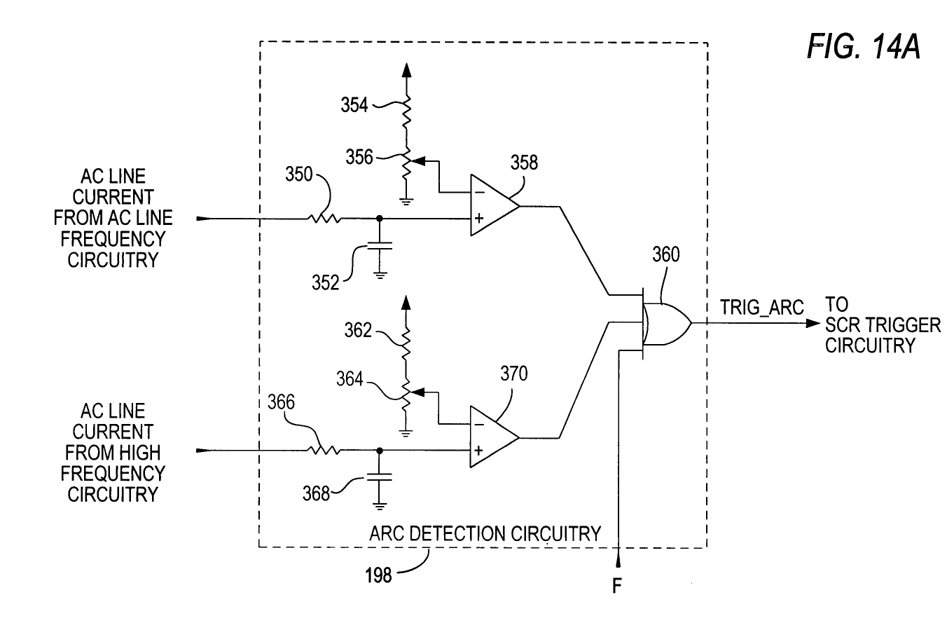

FIG. 12 is a schematic diagram of an implementation of a high frequency circuitry portion of the arc fault detection device of FIG. 7. The high pass filter 190 includes a first input LC network operable as a high pass filter, an amplifier and an active operational amplifier based high pass filter in series. The capacitor 242 is chosen to have negligible impedance for frequencies above approximately 500 KHz, while the inductor 246 is chosen to be an open circuit above 500 KHz. Thus, high frequencies pass through the filter. At low input frequencies, capacitor 242 has a high impedance and inductor 246 appears as a virtual short to ground, thus severely attenuating low frequency signals. The resistor 240 can help to prevent the LC network consisting of capacitor 242 and inductor 246 from resonating by dampening oscillations. Thus, the LC network functions as a high pass filter whose output is input to operational amplifier 250.

The gain of the operational amplifier 250, defined by resistors 248 and 254, is set to provide a suitable functional range of high frequency arcing signals for later signal processing operations. The resistor 252 can provide temperature compensation, permitting the detector to operate at temperatures higher than room temperature without any loss of accuracy. The operational amplifier 250 also functions as a buffer, producing a low impedance source for the series connected filter constructed around operational amplifier 264.

In the implementation shown, the filter comprises a two pole, active high pass Chebychev filter with a cut off frequency of approximately 500 KHz. The filter can provide provide high attenuation of signals below 500 KHz, thus preventing power line carrier communication signals present on the AC line from interfering with the detection of arc faults. The filter is constructed from capacitors 256, 258, resistors 262, 260 and operational amplifier 264. The resistor 266 is utilized for temperature compensation.

The output of the Chebychev filter is input to a full wave rectifier 192 which is capable of rectification at input voltages in the millivolt range. The rectifier 192 comprises an operational amplifier 272 whereby the positive input of the operational amplifier is held to ground by resistor 270. Diodes 276, 278 provide rectification of the signal. Due to the feedback through resistor 274, no loss in signal is achieved. Resistors 268, 274 define the gain of the rectification stage 192.

The pulsating high frequency DC signal output by the full wave rectifier 192 is input to an amplifier 194 comprising operational amplifier 282 and resistor 280. The amplifier 194 functions as a voltage follower or impedance matching buffer providing a low resistance source for the arc current signal which is representative of the peak level of arc current on the AC line. The arc current signal is the voltage of the high frequency processed signal, containing all the peaks and troughs of the original signal. If this voltage exceeds a predetermined level, the device will trip the relay and open up the input line from the load.

The output of the amplifier 194 is input to the integrator 196 which can generate a signal representative of the level of the average peak arc current present on the AC line. The integrator may have an integration time of approximately 100 ms. The buffered signal output from the full wave rectifier 192 is smoothed and averaged by a diode 284, resistors 288, 286 and capacitor 290. Resistor 286 and capacitor 290 are sufficiently large to smooth out the rapid fluctuations of the high frequency arcing signal and convert them to a slower moving DC level suitable for the arc detection circuit 198 (shown in FIG. 7). The resulting averaged arc current signal is output by a voltage follower/buffer 292.

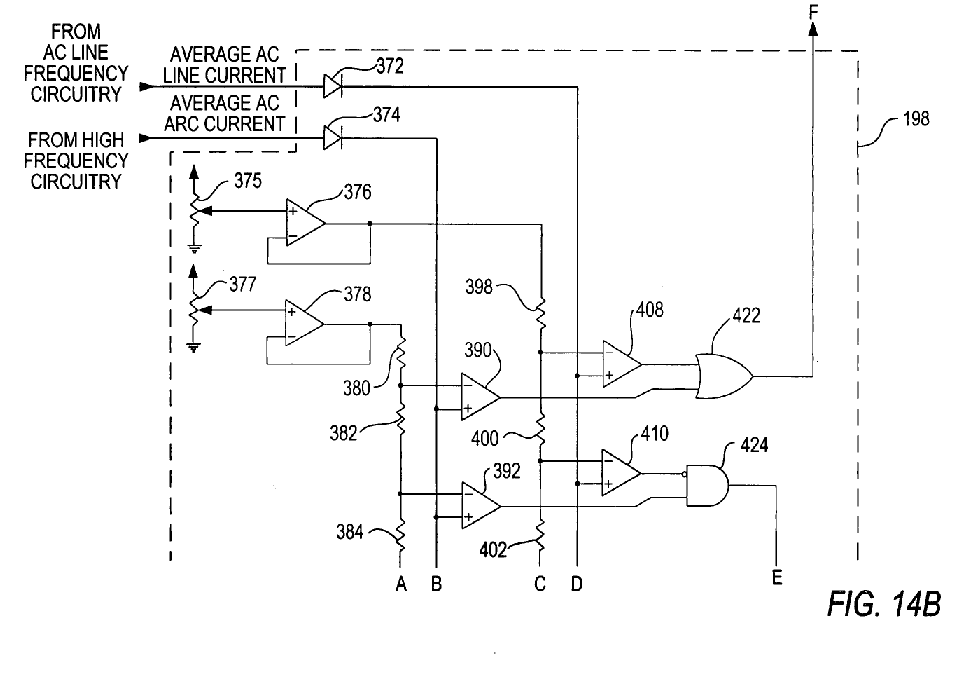

FIG. 13 is a schematic diagram of an implementation of an AC line frequency circuitry portion of the arc fault detection device of FIG. 7. The AC line frequency circuitry 200 acts as a low pass filter. A second input LC network of the low pass filter 202 includes a capacitor 302 and inductor 300. Frequencies less than 500 Hz can be passed with negligible attenuation. At low frequencies, inductor 300 is virtually a short circuit and capacitor 302 has high impedance. At frequencies above 500 Hz, the inductor 300 is high impedance and the capacitor 302 has low impedance thus attenuating any high frequency content in the input signal. The resistor 240 can prevent the second input LC network from resonating as well.

The output of the second input LC network is input to an amplifier that includes an operational amplifier 308 and resistors 304, 306, 310. The gain of the operational amplifier 308, defined by resistors 304, 306, is set so that the AC line frequency circuitry 200 provides 1 V per 10 A flowing on the AC power line. This current to voltage relationship permits the circuitry to detect and reject low level arcing such as may be produced by an appliances connected to the power strip. The resistor 310 provides temperature compensation. The operational amplifier circuit 308 also functions as a buffer producing a low impedance output source for the filter constructed around operational amplifier 322.

In the illustrated implementation, the filter coupled in series with operational amplifier circuit 308 is a two pole, active low pass Chebychev filter with a cut off frequency of approximately 500 Hz. The use of an active filter can provide a sharp cut off of high frequencies. The low pass filter is constructed from the resistors 312, 316, 320, capacitors 314, 318 and operational amplifier 322.

The output of the Chebychev filter is input to a full wave rectifier 204 which is capable of rectification at input voltages in the millivolt range. The rectifier 204 incldues an operational amplifier 330 where the positive input of the operational amplifier is held to ground by resistor 329. Diodes 328, 332 provide rectification of the signal. Due to the feedback via resistor 326, no loss in signal is achieved. Resistors 324, 326 define the gain of the rectification stage 204.

The pulsating low frequency DC signal output by the full wave rectifier 204 is input to an amplifier 206 having an operational amplifier 336 and resistor 334. The amplifier 206 functions as a voltage follower or impedance matching buffer providing a low resistance source for the AC line current signal which is representative of the peak level of AC line current on the electrical line that the AFCI/GFCI device is monitoring. The AC line current signal is the voltage of the low frequency processed signal, containing all the peaks and troughs of the original signal. If this voltage exceeds a predetermined level, the device will trip the relay.

The output of the amplifier 206 is input to the integrator 208 which functions to generate a signal representative of the level of the average peak AC line current. The integrator may have an integration time of approximately 100 ms. The buffered signal output from the full wave rectifier 204 is smoothed and averaged via diode 340, resistors 338, 342 and capacitor 344. Resistor 338 and capacitor 344 are sufficiently large to smooth out the fluctuations of the AC line frequency signal and convert them to a slower moving DC level suitable for the arc detection circuit 198 (shown in FIG. 7). The capacitor 344 is slowly discharged by resistor 342. The resulting averaged arc current signal is output by the voltage follower/buffer 346.

The resistors and capacitors in the averaging circuit 208 may be chosen to attenuate the signals generated by device that have high inrush which produce a short duration voltage spike which decays very quickly after the device is turned on.

Thus, the AC line frequency circuitry 200 outputs two signals, the first signal being proportional to the peak AC line current flowing in the power line and the second signal being proportional to the average AC line current flowing in the power line. The high frequency circuitry 188 also outputs two signals, the first signal proportional to the peak current of frequency components above 500 KHz (with the highest frequency limited by the physical characteristics of the components and operational amplifiers utilized) and the second signal proportional to the average current of frequency components above 500 KHz. All four of these signals are utilized by the arc detection circuit 198 (see FIG. 7) to permit the AFCI/GFCI circuit to react to a wide range of arcing conditions. Use of the four signals also can permit the AFCI/GFCI to disregard both inrush currents and noise which may be generated by devices, while reliably detecting undesired arcing conditions.

Alternatively, it may be possible to remove either the initial passive LC type filtering or the active filtering (operational amplifiers) and still provide sufficient filtering of the AC line frequency signal and any high frequency arcing signals for the device to work as intended. Ensuring the attenuation of any signals in the frequency bands used for power line carrier communications would also be a consideration.

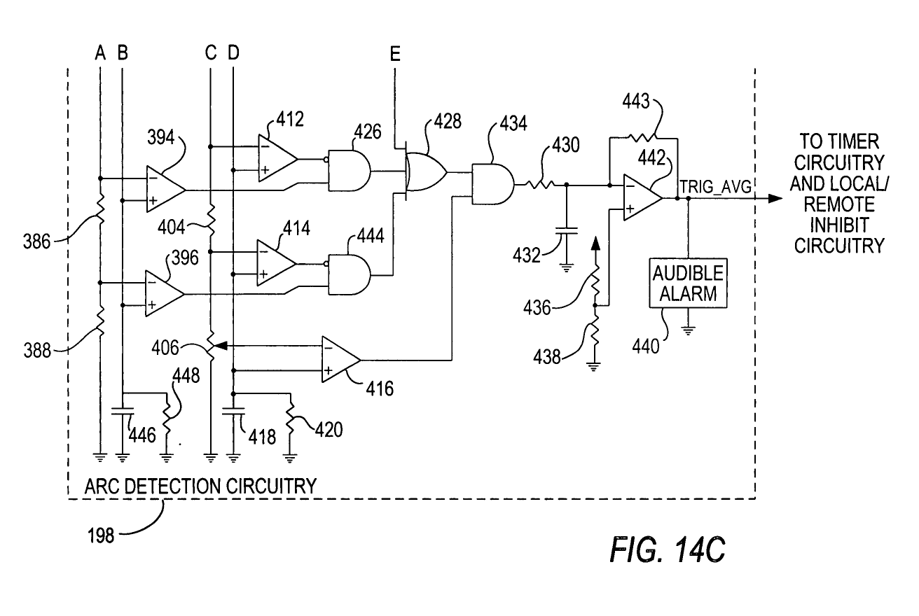

FIGS. 14A, 14B and 14C are schematic diagrams of an implementation of the arc detection circuitry portion of the arc fault detection device. The arc detection circuitry functions to generate two trigger signals termed TRIG_ARC and TRIG_AVG. The generation of the first signal TRIG_ARC will be described first. With reference to FIG. 14A, the arc detection circuitry is operative to detect when the peak AC line frequency current or the peak high frequency arc current is above a predetermined threshold that has been determined to be unsafe. The peak AC line frequency current from the AC line frequency circuitry 200 (FIG. 13) is smoothed by resistor 350 and capacitor 352 before being input to comparator 358. The minus input of the comparator is the output of a voltage divider which serves as a reference voltage. Resistor 354 and potentiometer 356 form the voltage divider. This reference voltage is set to a value representing the highest permissible peak AC line current on the AC line. Preferably, the highest permissible peak AC line current is 100 A. When the AC line frequency peak voltage is higher than the set threshold, the normally low output of the comparator 358 will go high. If the other inputs to the OR gate 360 were previously low then comparator 358 going high causes the signal TRIG_ARC to go high. This, in turn, causes the SCR trigger circuit 236 (see FIG. 8) to trigger the SCR and open the relay, disconnecting the power to the load. This circuit is particularly useful for detecting short duration, undesired arcing, where appreciable load current is flowing through the arc and the power line such as when an extension cord is cut by the sharp edge of a metal chair leg.

Similarly, the peak high frequency current from the high frequency circuitry 188 (see FIG. 12) is smoothed by resistor 366 and capacitor 368 before being input to comparator 370. The minus input of the comparator is the output of a voltage divider which serves as a reference voltage. Resistor 362 and potentiometer 364 form the voltage divider. This reference voltage is set to a value representing the highest permissible peak high frequency arc current on the AC line. When the high frequency peak voltage is higher than the set threshold, the normally low output of the comparator 370 will go high. If the other inputs to the OR gate 360 were previously low then comparator 370 going high causes the signal TRIG_ARC to go high. This, in turn, causes the SCR trigger circuit 236 (FIG. 8) to trigger the SCR and open the relay, disconnecting the power to the load. This circuit is particularly useful for detecting short duration, undesired arcing, where a load current is flowing through the arc and the power line, for example, when an extension cord is shorted.

Both the peak AC line frequency and peak high frequency comparator circuits can be constructed such that the relay in the AFCI/GFCI will trip within approximately three AC cycles, (40 milliseconds), when 100 A of arcing and/or AC line over current conditions are detected. This level of detection and speed of tripping is termed Level 3 priority. The two other levels, Levels 2 and 1 are lower in priority and consequently more time may be needed before the relay is tripped.

The quick response associated with Level 3 priority arcing and over current situations can be achieved by using the peak voltages output from the AC line and high frequency circuits rather than the average voltages. This can provide a rapid tripping reaction to excessive inrush currents. In addition, it also provides extra margin for detecting very large arcs, as these may have a large AC line frequency component and a sufficient amount of energy to start a fire.

The arc detection can provide a fast response to a wide range of dangerous scenarios. The device utilizes the two comparators 358, 370 to turn off the AC power to the load in the following three different situations: (1) when the line has high levels of arcing; (2) when the peak AC line current exceeds the line's capacity; and (3) when the line is overloaded due to excessive arcing.

A peak inrush current of approximately 130 A would normally generate sufficient voltage to trip the AFCI/GFCI. However, capacitors 352 and 368 (see FIG. 14A) generate a time delay. The values of capacitors 352, 368 may be chosen to provide a time delay of approximately 25 ms for the comparators 358, 370, respectively. This time delay can reduce false tripping by inrush currents as different devices are connected because comparators 358, 370 are configured to trip within 40 ms at 100 A load current.

The next lower priority level, Level 2, is associated with high average arcing, i.e., average AC line frequency current or average high frequency arc current greater than 1.5 times the rating of the AFCI/GFCI. At this priority level the comparator circuit may set the relay in the AFCI/GFCI device to trip within 100 ms.

The circuitry used to implement Level 2 priority will now be described in more detail. With reference to FIG. 14B, the average AC line current from the AC line frequency circuitry is input to the plus input of the comparator 408. A voltage reference source is input to the minus input of the comparator 408. The reference voltage is generated by potentiometer 375 and operational amplifier 376 which form a voltage regulating circuit. The voltage regulating circuit can provide the adjustable reference voltage for a resistive divider network which includes resistors 398, 400, 402, 404, 406. The values of the resistors may be chosen to create multiple reference levels of average AC line frequency current, e.g., 30, 20, 10, 5 and 2.5 A. The reference voltage created at the minus input to comparator 408 corresponds to an average AC current of 30 A on the AC line. Thus, if the level of average AC line current detected is above 30 A, the output of the comparator 408 goes high causing the output of the OR gate 422 to go high. The output of OR gate 422 is input to the OR gate 360 which functions to output the TRIG_ARC signal to the SCR trigger circuit.

Similarly, a voltage reference source is input to the minus input of the comparator 390. The reference voltage is generated by potentiometer 377 and operational amplifier 378 which forms a voltage regulating circuit. The voltage regulating circuit provides the adjustable reference voltage for a resistive divider network which comprises resistors 380, 382, 384, 386, 388. The values of the resistors are chosen to create multiple reference levels of arcing current, e.g., dangerous, high, medium and low. The reference voltage created at the minus input to comparator 390 corresponds to a dangerous arcing level. Thus, if the level of average high frequency current detected is above this level, the output of the comparator 390 goes high causing the output of the OR gate 422 to go high. The output of OR gate 422 is input to the OR gate 360 which functions to output the TRIG_ARC signal to the SCR trigger circuit.

The two comparators 390, 408 can output a high in the presence of unsafe conditions. The comparators are connected through OR gates to the SCR trigger circuit controlling the AFCI/GFCI relay. This provides Level 2 priority tripping with a trip time of approximately 100 ms. This fast trip cannot be disabled nor delayed by the user, as with Level 1 priority detection.

The output of comparator 390 goes high if unsafe arcing persists for approximately 100 ms, while the output of comparator 408 goes high if the total average current exceeds 30 A for a time duration of approximately 100 ms, i.e., six AC cycles. An average AC line current of 30 A indicates that the AFCI/GFCI safe feed through current capability is being exceeded by 50 to 100%. The comparator 390 reacts to high frequency currents while comparator 408 reacts to AC line frequency, i.e., 50 or 60 Hz. The output of comparator 408 goes high when the average current exceeds 30 A on the AC power line. In this fashion the device provides over current protection against continuous overloading, as well as protection against excessive peak currents exceeding 100 A for longer than 2 to 3 AC cycles.

The arc detection circuitry also includess two banks of comparators, one associated with the average AC line current and the other associated with the average high frequency arcing current. Three comparators 410, 412, 414 have their minus inputs tapped into different reference voltage levels generated by the resistor divider 398, 400, 402, 404. The plus input of each comparator is coupled to the average AC line current voltage. The resistor values may be chosen so that the output of comparator 410 will go high when the average AC line current exceeds 20 A, the output of comparator 412 will go high when the average AC line current exceeds 10 A and the output of comparator 414 will go high when the average AC line current exceeds 5 A. As previously described, the output of the comparator 408 will go high when the average AC line current exceeds the dangerous level of 30 A.

The average AC line current signal is fed to comparators 408, 410, 412, 414 through diode 372. A capacitor 418 provides further smoothing of the average AC line current signal and resistor 420 ensures that capacitor 418 discharges when the average AC line current decreases. Additional feedback resistors can be added to the plus inputs of the comparators to provide hysteresis thus reducing oscillations.

Similarly, the arc detection circuit comprises comparators 392, 394, 396 for detecting various levels of average arcing current on the line. The minus inputs of each of the comparators is coupled to different taps on the voltage divider which includes resistors 380, 382, 384, 386, 388. The values of the voltage divider resistors can be calculated to switch the output of the comparator 396 high when the average arcing current level exceeds a ‘low’ level. A ‘low’ arcing level may be defined as the minimum arcing level required to start a fire. The output of the comparator 394 goes high when the average arcing current exceeds a ‘medium’ level. The output of the comparator 392 goes high when the average arcing current level exceeds a ‘high’ level. As previously described, the output of the comparator 390 goes high when the average arcing current level exceeds a level considered ‘dangerous’ under any circumstance. A ‘dangerous’ level is defined as the amount of arcing that would produce an average arcing current of 30 A.

The average arcing current voltage signal is fed to comparators 390, 392, 394, 396 through diode 374. The capacitor 446 provides further smoothing of the average arc current signal and resistor 448 provides a discharge path for capacitor 446. Additional feedback resistors can be added to the plus inputs of each of the comparators to provide hysteresis thus reducing oscillations.

Note that the integrator circuits in the AC line and high frequency circuitry that provide the input to the arc detection circuitry create a time delay of approximately 85 to 100 ms. The time delay can prevent the relay from tripping and disconnecting the power during a current inrush, which always occurs when inductive, capacitive or incandescent loads are turned on.

Alternatively, a delayed tripping mechanism is provided for signals with lower average arcing. These signals are given Level 1 priority. Level 1 is the lowest priority and the AFCI in the power strip will trip within 1 to 2 seconds at this level of arcing. In addition, the user has the option of delaying or preventing tripping due to Level 1 arcing through the timer circuit described in more detail hereinbelow. The user can also enable an audible warning device rather than have the AFCI/GFCI trip.

Various levels of detection may be provided by the two comparator configurations 390, 392, 394, 396 and 408, 410, 412, 414. The device is able to react appropriately to different levels of average AC line current and average arc current by applying the output of the comparators to a logic circuit.

In particular, the comparators 392, 410 are associated with high level arc detection, comparators 394, 412 with medium level arc detection and comparators 396, 414 are associated with low level arc detection. These various levels of arcing produce a Level 1 priority trip. Below a certain average arcing current level, an arc can be considered non dangerous because it has insufficient energy to start a fire. An example of non dangerous arcing could be a static electricity discharge. The reference voltage provided to comparator 396 by the voltage divider represents an average arcing current level containing the minimum amount of energy to start a fire. This is the lowest detection point and has been experimentally determined by analyzing many arcing wave signatures.

The reference voltage for comparator 414 is preferably set to 0.5 V. This reference voltage is calculated to equal the DC voltage of the average AC line current signal when 5 A of current flows on the load side of the AFCI/GFCI device. When the average arc current signal reaches the minimum level required to be dangerous, i.e., ‘low’ level, the output of comparator 396 goes high. The output of the comparator 396 is input to one input of the AND gate 444. The output of comparator 414 is inverted and input to the second input of the AND gate 444. Thus, the output of AND gate 444 is high only when the a ‘low,’ i.e., minimum dangerous, arcing level is detected and less than 5 A flows in the load line.

The reference voltage for comparator 412 is preferably set to 1 V. This reference voltage is calculated to equal the DC voltage of the average AC line current signal when 10 A of current flows on the load side of the AFCI/GFCI device. When the average arc current signal reaches the ‘medium’ level, the output of comparator 394 goes high. The output of the comparator 394 is input to one input of the AND gate 426. The output of comparator 412 is inverted and input to the second input of the AND gate 426. Thus, the output of AND gate 426 is high only when the ‘medium’ arcing level is detected and less than 10 A flows in the load line.

The reference voltage for comparator 410 is preferably set to 2 V. This reference voltage is calculated to equal the DC voltage of the average AC line current signal when 20 A of current flows on the load side of the AFCI/GFCI device. When the average arc current signal reaches the ‘high’ level, the output of comparator 392 goes high. The output of the comparator 392 is input to one input of the AND gate 424. The output of comparator 410 is inverted and input to the second input of the AND gate 424. Thus, the output of AND gate 424 is high only when the a ‘high’ arcing level is detected and less than 20 A flows in the load line.

The table below summarizes the average arcing required for the various priority trip levels. Note that peak AC line current or peak high frequency arcing current in excess of 100 A will immediately trip the device. This is a Level 3 priority trip. Table I only describes average current trip levels.

TABLE I

| Average AC | Average High Frequency Arc Current | | | | |
|---|---|---|---|---|---|
| Line Current | None | Low | Medium | High | Dangerous |
| <2.5 A | No Trip | No Trip | No Trip | No Trip | Level 2 |
| <5 A | No Trip | Level 1 | Level 1 | Level 1 | Level 2 |
| <10 A | No Trip | No Trip | Level 1 | Level 1 | Level 2 |
| <20 A | No Trip | No Trip | No Trip | Level 1 | Level 2 |
| <30 A | No Trip | No Trip | No Trip | No Trip | Level 2 |
| ≧30 A | Level 2 | Level 2 | Level 2 | Level 2 | Level 2 |

Note that the example arc detection circuit of FIGS. 14A, 14B and 14C is shown having three levels of average arc current detection, i.e., high, medium and low, for illustrative purposes only. Higher or lower levels of average arc current detection are possible without departing from the scope of the disclosure. Alternatively, since relatively slowly changing DC levels are involved, A/D converters could be utilized to digitize the average Ac line and high frequency signals for input into a microcontroller. The microcontroller would be suitably programmed to generate an output dependent upon the levels of the two input signals. The microcontroller could also perform a hysteresis function in software for each detection level.

As described above, the output of each of the AND gates goes high only if the average arc current detected is greater than the level permitted for a particular level of average AC line current. This also implies that for every level of average AC line current, there is a level of average arc current which is tolerated, for example, as a byproduct of the particular load including vacuum cleaners, electric shavers and food processing appliances. These common appliances each can have an amount of arcing associated with their operation. The level of arcing signal produced by these appliances may be lower than the signal from an uncontrolled arc with the same current flow. Thus, because the arc detection circuitry tolerates a specific amount of arcing for each level of AC line current, false tripping of the device is prevented whenever these types of appliances are used.

The outputs of the AND gates 424, 426, 444 are input to an OR gate 428. If any of the outputs of the AND gate go high, the output of the OR gate 428 goes high. The output of the OR gate 428 is input to AND gate 434.

An additional comparator 416 may be included in the arc detection circuit to eliminate any false tripping due to noise on the AC line. The noise may be created by spikes generated by various sources, RF pickup or electrostatic discharge such as when someone walks on a dry nylon carpet and touches the housing of an outlet or extension cord. In addition, an appliance like an electric shaver, may generate a substantial amount of arcing noise yet consume minimal current possibly falsely tripping the device. The comparator 416 can cause these above type disturbances, white noise, light dimmer noise, etc. to be ignored, therefore increasing the noise immunity of the arc detector.

The comparator 416 is at the lowest position on the totem pole structure for average AC line current detection. The reference voltage, input to the minus input of the comparator, is set by the variable resistor 406. Comparator 416 functions to keep the output of AND gate 434 low when less than a minimum current level is flowing through the AFCI/GFCI. The output of the AND gate 434 can only go high if the average AC line current is above a minimum level. In the example presented herein, this level is arbitrarily set to 2.5 A. Thus, only arc faults that contain sufficient energy to start a fire will trip the arc detector.

Electrical energy can be represented as p=I²R or VI, where P is power, I is current, R is resistance and V is voltage. As the current, I, approaches zero, the energy in an arc approaches zero. Hence, the power becomes negligibly small and it can be considered a static arc. As an illustrative example, walking on a dry nylon carpet can produce a static voltage of 50,000 V yet the current may be only a few μA. Thus, the total energy in the arc is in the milliwatt (mW) range which may not be sufficient to start a fire.

The output of the AND gate 434 is input to the plus input of comparator 442 through a resistor 430 and capacitor 432. The resistor 430 and capacitor 432 function to generate a delay, for example, of 1 to 2 seconds. Small short-lived arcs that persist for longer than 100 milliseconds (ms), but are not continuous, may not normally dangerous. The 1 to 2 second delay causes these intermittent arcs to be ignored, e.g., those produced by opening and closing switches. The delay also provides greater noise immunity from sporadic or short lived noise sources such as lighting controls. The output of comparator 442 goes high when the voltage on the capacitor 432 exceeds the reference voltage set by the divider 436, 438. Hysteresis can provided by resistor 443 which prevents the comparator from oscillating. The comparator 442 also functions as a buffer for the following stages. The output of comparator 442 is input to the timer circuitry and local/remote inhibit circuitry. In addition, the output of the comparator 442 can optionally be input to an audible alarm 440 which can comprise a buzzer or other type of well known audible alarm device. Optionally, a user controlled switch can be connected to the output of the comparator 442 to provide the option of driving the audible alarm indicating a Level 1 priority arc fault or to trip the device via the timer circuitry described hereinbelow.

The present disclosure can include timer circuitry 186 (see FIG. 7) to temporarily disable the detection of arc faults for a period of time. The detection of any arcing during the time that the detector output is disabled, can cause the period of disablement to extend by a time equal to the total time that arcing is detected. Thus, if arc detection is disabled for one hour and 10 minutes, and arcing is detected during that time, the detector becomes enabled one hour and 10 minutes later. In this manner, arc detection can remain disabled for longer periods of time thus permitting the user uninterrupted use of the equipment or appliance.

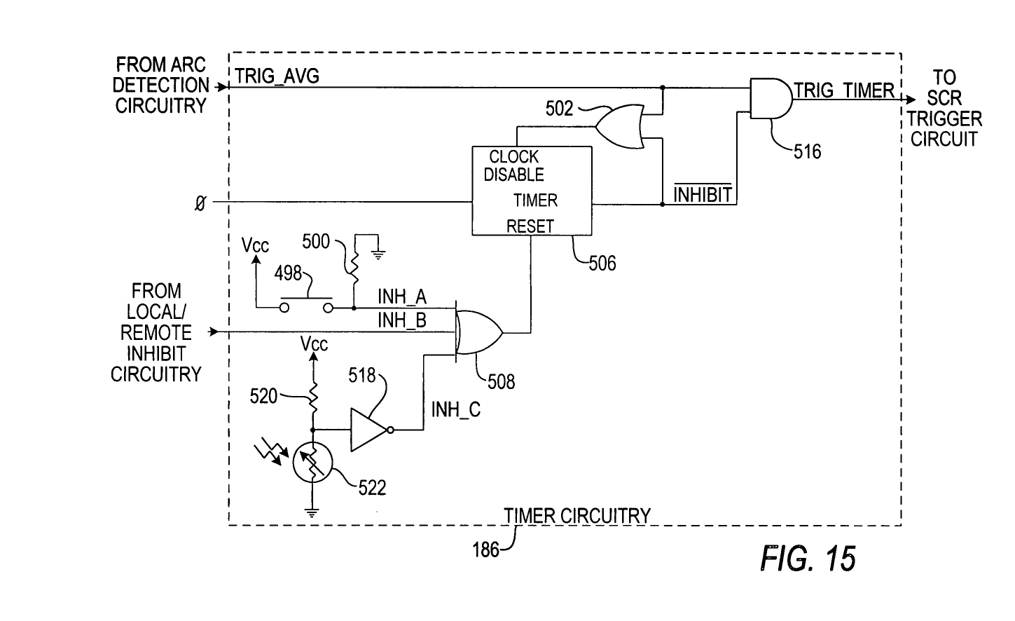

FIG. 15 illustrates schematic diagram of an implementation of the timer circuitry portion of the arc fault detection device. The timer circuitry 186 can generate an active low \overline{INHIBIT} signal that is gated with the Level 1 priority related TRIG_AVG signal output by the arc detection circuitry. The \overline{INHIBIT} signal is generated by a timer 506 and is normally high. The \overline{INHIBIT} signal is gated with the TRIG_AVG signal by AND gate 516 to generate the TRIG_TIMER signal. The TRIG_TIMER signal is then input to the SCR trigger circuit 236 (see FIG. 8). Because the output of the timer is normally high, the TRIG_AVG signal is normally enabled so that the relay can trip. The application of an active high pulse to the RESET input of the timer starts the timer running. When a pulse is applied the reset input, the \overline{INHIBIT} signal is pulled low until the timer count reaches a specified number of clock cycles. During the time that the \overline{INHIBIT} signal is low, the TRIG_TIMER signal is disabled. After the disablement of the timer ends, the \overline{INHIBIT} signal returns to the active high state.

The 50 or 60 Hz phase conductor of the AC line can serve as a clock source for the timer 506. The timer includes zero detecting means for detecting the zero crossings of the AC wave which forms the timer input clock signal. Within the timer, the 50 or 60 Hz high voltage sine wave is converted to a low voltage square wave of the same frequency. The timer also includes counting means, such as a plurality of Johnson counters. The internally generated square wave is used as the clock input for the counters. By suitable selection of the counter means, any time period can be arbitrarily generated by the timer. For example, with 60 Hz AC power and a divide by 216,000 counter, the timer output returns to a high state one hour after being reset.

A gate (not shown) may separate the clock generator from the counters within the timer. This gate is controlled by an input labeled CLOCK DISABLE, which is internally latched. When the CLOCK DISABLE input is high, the clock is prevented from driving the counters. Thus, the timer is “paused” until the CLOCK DISABLE input is removed. When the CLOCK DISABLE input is returned to active low the timer resumes counting from the point at which it paused.

The timer also comprises a RESET input. An active high pulse on the RESET input forces the output of the timer, i.e., the \overline{INHIBIT} signal, low and sets all the counter registers to zero. The timer is preferably of the resettable type, that is, it can be made to start counting from zero at any time, even during counting. A continuous active high on the RESET input will keep the counter at zero and therefore keep the \overline{INHIBIT} signal permanently low.

When the \overline{INHIBIT} signal is high, the CLOCK DISABLE input of the timer is pulled high via the output of OR gate 502. This can prevent the timer from counting further and latches the timer in a high output state.

As described previously, the detection of a priority Level 1 arc fault may extend the period of disablement. Assuming the \overline{INHIBIT} signal is low, i.e., the timer is counting, a high TRIG_AVG signal will produce a high at the CLOCK DISABLE input of the timer through the OR gate 502. Thus, the timer pauses for the period of time that the TRIG_AVG signal is high. The re-enabling of the TRIG_TIMER signal is delayed by the amount of time that the TRIG_AVG signal is high. If the timer is not counting, i.e., the \overline{INHIBIT} signal is high, then the TRIG_AVG signal has no effect on the timer.

This method of delaying the timer is used to ensure that the TRIG_TIMER signal will always be re-enabled, even if arcing starts while the timer is counting. Priority Level 1 arcing is intermittent in form, as there is not enough energy to sustain arcing for long periods. Therefore, even if Priority Level 1 arcing starts while the timer is counting, the counter will still be incremented during the gaps between arcing, and arc detection will be enabled at some time after arcing began. Thus, the timer circuit reduces tripping due to the normal arcing generated by equipment and appliances, while ensuring that the GFCI/AFCI will eventually trip in the presence of arcs. Note that arcing at Priority Levels 2 and 3 may not be disabled.

While the timer is counting, the \overline{INHIBIT} signal is low, thus disabling the TRIG_TIMER signal. A light emitting diode (LED) 512 can be connected to the output of the timer 506. The LED also may be connected to the power supply VCC through a current limiting resistor 510. When the \overline{INHIBIT} signal is low, the LED is illuminated to indicate that arc detection has been temporarily disabled. When the \overline{INHIBIT} signal is high the LED is extinguished indicating that arc detection is enabled.

Three signals combine to form the RESET signal: INH_A, INH_B and INH_C. These three signals are gated together through OR gate 508 to generate the RESET signal input to the RESET input of timer 506. Thus, INH_A, INH_B or INH_C going high will reset the timer. The three signals input to the OR gate 508 will now be described in more detail.

The timer can be reset by a user by pressing a momentary push button switch 498. The INH_A signal, which is normally pulled low through resistor 500 tied to ground, is momentarily pulled active high. One alternative is to gang the switch 498 to the switch mechanism that provides the test pulse for the GFCI circuit. Arc detection is then disabled for a predetermined time period when the GFCI is tested. In other words, testing the GFCI before an appliance like a vacuum cleaner is used in the house will ensure that the device will not trip when the vacuum is used. Arc detection is automatically enabled a timer period after use of the arc generating appliance is disconnected.

As described previously, the output of the timer is normally high, allowing arc detection. One alternative is for the \overline{INHIBIT} signal to go high immediately upon the power first being applied to the AFCI device. An alternative is for the timer to be reset upon power being applied. A third and preferred alternative is for the \overline{INHIBIT} signal to be pulled low for a few AC cycles, e.g., 1 second, and then permitted allowed to go active high. It produces greater noise immunity, as the transients associated with the power being applied will be ignored by the AFCI circuitry. Moreover, the AFCI is not inhibited for a long period of time unnecessarily.

When arc generating machinery is used throughout the day, such as in a factory with arc generating machinery, the detection of arc faults may only be practical at night. Thus, the AFCI could be disabled during the day and enabled at night. A photocell 522 can be provided to inhibit Level 1 priority arc faults from tripping the device. The photocell 522 is connected to VCC through resistor 520. During daylight hours, the resistance of the photocell drops causing a low at the input to inverter 518. The output of the inverter INH_C goes high causing the RESET input of the timer to go high. This disables the TRIG_AVG signal from tripping the device. Conversely, at night or in the absence of light, the resistance of the photocell 522 rises to a high value causing the input to the inverter 518 to go high. The inverter output goes low, removing the INH_C signal, enabling the timer and permitting the arc detector to trip. In the absence of light, the resistance of the photocell may rise to 100 MΩ or more.

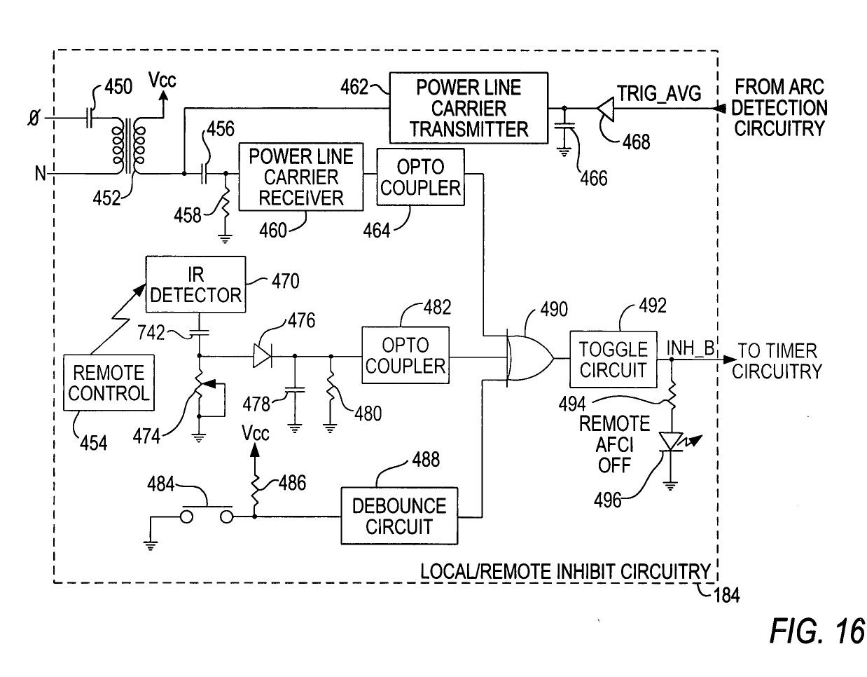

A third source, INH_B, for the RESET input is also input to the OR gate 514. This INH_B signal is generated by the local/remote inhibit circuitry which will now be described in more detail. FIG. 16 illustrates a schematic diagram of an implementation of the local/remote inhibit circuitry portion of the arc fault detection device. The local/remote inhibit circuitry 184 comprises circuitry that also inhibits the TRIG_AVG signal from tripping the device. The local/remote inhibit circuitry 184 can be constructed as an integral part of the AFCI/GFCI device or it can be constructed in its own external housing and connected to the main embodiment by a plurality of conductors. The local/remote inhibit circuitry can turn the device on and off via momentary push button, turn the AFCI on and off through an infrared receiver, turn the AFCI on and off by a signal from any suitable communication means and send a signal across any suitable communication means, indicating the occurrence of an arc fault, to a remotely located receiver.

Infrared (IR) reception is achieved through an IR detector 470 which may include an infrared diode to pickup the pulsing signal from an IR transmitter 454. The transmitter may include a fixed transmitter or, in the alternative, any TV or stereo remote control that emits IR pulses modulated by a frequency in the range of 30 to 45 KHz. A receiving diode in the IR detector 470 changes its impedance upon reception of IR pulsing energy. The capacitor 472 passes these pulses through to resistor 474 while blocking DC. This can limit the sensitivity of the device to any constant or slowly changing light level, e.g., daylight. The pulsating DC across potentiometer 474 charges the capacitor 478 through diode 476. The resulting DC level is input to an opto coupler 482. Current flowing to the input of the opto coupler causes its output to go high. The output of the opto coupler is input to an OR gate 490. A high output of the opto-coupler causes the output of the OR gate to go high.

The output of an OR gate 490 is input to a toggle circuit 492. The toggle circuit 492 operates in one of two alternative, user selected modes. In the first mode, the toggle circuit 492 functions to flip its output from low to high to high to low upon each low to high transistor of its input. In the second mode, the toggle circuit 492 functions to produce an active high pulse upon each low to high transition of its input.

The output of the toggle circuit 492 forms the INH_B signal, which is input to the OR gate 508 (FIG. 15). In the first toggle switch mode, the INH_B signal is held high until another input to the toggle circuit occurs. The arc detector is disabled until the local/remote inhibit circuitry releases the INH_B signal. In the second toggle switch mode, the INH_B pulse resets the timer but the AFCI is enabled automatically after the predetermined time period.

The status of the output of the local/remote inhibit circuit output can be indicated by LED 496, which is connected to INH_B through resistor 494. In the first toggle switch mode, the lighted LED indicates that the AFCI is being disabled via remote means. In the second toggle switch mode, a flash of the LED 496 indicates that a reset pulse has been sent to the timer 506 (see FIG. 15).

The circuitry 184 also can include circuitry to enable a user to reset the timer or permanently disable the AFCI/GFCI device from a remote location. One end of momentary push button switch 484 is connected to ground and the other end is connected to a denounce circuit 488. The input to the denounce circuit 488 is help high by resistor 486 tied to VCC. The output of the denounce circuit is input to OR gate 490. The denounce circuit can output a low while the switch 484 is open. When the switch is closed, the output of the denounce circuit 488 goes high causing the output of the OR gate 490 to go high, toggling the INH_B signal.

The local/remote inhibit circuitry 184 also can include a capability to receive an on/off command through a communication means. For example, such communication means may be a power line carrier, RF, twisted pair or IR communication technology. An example of power line carrier communications include Lon Works and CEBus communications systems. By way of example only, the present disclosure includes a power line carrier receiver 460, such as the CCS receiver manufactured by Leviton Manufacturing, Little Neck, N.Y., to receive a signal transmitted over the power line, decode and interpret the received command and output a signal to the opto-coupler 464. The CCS power line carrier signal is modulated by a carrier of 121 KHz. This signal is extracted from the AC line through capacitor 450 and coupling transformer 452. The capacitor 456 and resistor 458 function to high pass filter the input to the receiver 460. The output of the opto coupler 464 is input to the OR gate 490. Thus, a high output of the opto coupler 464 causes the INH_B output of the toggle circuit 492 to change states.

The present disclosure can include communication means, e.g., power line carrier transmitter 462, to transmit arc fault information to a remotely located receiver, pinpointing the location of the fault. Other types of communications may be substituted for power line carrier without departing from the scope of the disclosure. A dedicated indicator panel can be connected to the remote receiver where arc fault information is monitored by building personnel. This feature can be desirable in industrial or commercial facilities including schools and supermarkets where the electrical system is centrally supervised.

The TRIG_AVG signal from the arc detection circuitry is input to buffer 468 whose output is smoothed by capacitor 466. The output of the buffer 468 is input to the transmitter 462 to generate an output signal based on the state of TRIG_AVG. Though arcing may cease or be intermittent, the capacitor 466 maintains sufficient charge to keep the transmitter 462 activated long enough to transmit the required information through the AC line. The transmitter 462 includes power transistor means to transfer the output of the transmitter onto the AC line via the line side phase and neutral terminals. The phase and neutral line connections and the indicator panel are located upstream of the AFCI/GFCI so that they are not disconnected in the event the device trips.

Even if the timer has been triggered, temporarily inhibiting the TRIG_AVG signal, the occurrence of an arc fault is nevertheless transmitted to the remote indicator via the transmitter 462. It is desirable to have an indication of an arc fault even if it is generated from equipment or appliances. Alternatively, the TRIG_TIMER signal can be input to the transmitter 462 thus preventing notification of arc faults while the \overline{INHIBIT} signal is low.

As discussed previously, the arc detector can be used as a stand alone arc fault detector or combined with other types of circuit devices such as a transient voltage surge suppressor in addition to an interrupting device such as a GFCI. When used as a stand alone device, the AFCI/GFCI circuit of FIG. 8 is modified to include only arc fault related circuitry. In particular, the two GFCI related transformers 233, 234 and their related circuitry including the LM1851 IC 225 would be removed. The SCR trigger circuit 236 would need only two inputs, i.e., TRIG_ARC and TRIG_TIMER. The remainder of the circuit would remain, i.e., MOV, diode bride, coil, power supply, relay switches, etc.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

1. A power outlet strip comprising:
an input adapted to be coupled to an alternating current (AC) supply;
an arc fault circuit interrupter coupled to the input; and
at least one outlet receptacle coupled to the arc fault circuit interrupter.

2. The power strip of claim 1, comprising:
at least one additional circuit interrupting device coupled to the input,
wherein the arc fault circuit interrupter and the at least one additional circuit interrupting device operate independently from one another but share common components.

3. The power strip of claim 2, wherein the circuit interrupting device is at least one selected from the group consisting of a ground fault circuit interrupter, immersion detection circuit interrupter and appliance leakage circuit interrupter.

4. The power strip of claim 2, comprising a transient voltage surge suppressor.

5. The power strip of claim 4, comprising:
a data line input connector; and
one or more data line outlet connectors to couple the data line input to external devices,
wherein the data line outlets are coupled to the at least one circuit interrupting device.

6. The power strip of claim 5, wherein the data line outlet connector is at least one selected from the group consisting of a telephone, a modem, a cable television (CATV), Ethernet, BNC, video, token ring, satellite and digital subscriber line (DSL).

7. The power strip of claim 1, comprising a transient voltage surge suppressor.

8. The power strip of claim 7, comprising:
a data line input connector; and
one or more data line outlet connectors to couple the data line input to external devices,
wherein the data line outlets are coupled to the at least one circuit interrupting device.

9. The power strip of claim 5, wherein the data line outlet connector is at least one selected from the group consisting of a telephone, a modem, a cable television (CATV), Ethernet, BNC, video, token ring, satellite and digital subscriber line (DSL).

10. A method of protecting a power strip, comprising:
coupling an input to an arc fault circuit interrupter;
coupling the arc fault circuit interrupter to at least one other circuit interrupting device; and
coupling an output of the at least one other circuit interrupting device to an output receptacle,
wherein the arc fault circuit interrupter and the at least one additional circuit interrupting device operate independently from one another but share common components.

11. A method of interrupting a input signal from an output receptacle, comprising:
receiving the input signal;
coupling the input signal to an arc fault circuit interrupter;
coupling the input signal to at least one other circuit interrupting device;
providing an output of the circuit interrupting device to the output receptacle; and
disconnecting the input signal from the output receptacle in response to a signal from the arc fault circuit interrupter or the at least one other circuit interrupting device;
wherein the arc fault circuit interrupter and the at least one additional circuit interrupting device operate independently from one another but share common components.

12. The method of claim 11, wherein the circuit interrupting device is at least one selected from the group consisting of a ground fault circuit interrupter, immersion detection circuit interrupter and appliance leakage circuit interrupter.

13. The method of claim 11, comprising providing a transient voltage surge suppressor across the input signal.

14. The method of claim 13, wherein the data line outlet connector is at least one selected from the group consisting of a telephone, a modem, a cable television (CATV), Ethernet, BNC, video, token ring, satellite and digital subscriber line (DSL).
